(19) United States
(12) Patent Application Publication
(10) Pub. No.: US 2013/0019175 A1
(43) Pub. Date: Jan. 17, 2013

(54) SUBMENUS FOR CONTEXT BASED MENU SYSTEM

(71) Applicants: Matthew Kotler, Sammamish, WA (US); Erez Kikin Gil, Redmond, WA (US); Vignesh Sachidanandam, Mercer Island, WA (US); Mark Pearson, Renton, WA (US); Andrew Hockman, Seattle, WA (US); Ned Friend, Seattle, WA (US)

(72) Inventors: Matthew Kotler, Sammamish, WA (US); Erez Kikin Gil, Redmond, WA (US); Vignesh Sachidanandam, Mercer Island, WA (US); Mark Pearson, Renton, WA (US); Andrew Hockman, Seattle, WA (US); Ned Friend, Seattle, WA (US)

(73) Assignee: Microsoft Corporation, Redmond, WA (US)

(21) Appl. No.: 13/284,236

(22) Filed: Oct. 28, 2011

Related U.S. Application Data
(60) Provisional application No. 61/507,983, filed on Jul. 14, 2011.

(51) Int. Cl. G06F 3/048; G06F 3/16

(52) U.S. Cl. 715/728; 715/841; 715/834; 715/828

(57) ABSTRACT

One or more submenus associated with context based menus are provided. A context based menu may include top level commands/items available for execution on selected content or activation of submenu(s) that include additional executable commands. Additional commands may be executed through the submenu(s) by tap, swipe, or press and hold actions. Upon selection of a termination item or execution of a command, a submenu may be hidden and/or a parent menu displayed.

### CROSS REFERENCE TO RELATED APPLICATIONS

This application claims the benefit of U.S. Provisional Patent Application Ser. No. 61/507,983 filed on Jul. 14, 2011. The disclosures of the provisional patent application are hereby incorporated by reference for all purposes.

### BACKGROUND

With the proliferation of computing and networking technologies, two aspects of computing devices have become prevalent: non-traditional (e.g., mouse and keyboard) input mechanisms and smaller form factors. User interfaces for all kinds of software applications have been designed taking typical screen sizes and input mechanisms into account. Thus, user interactions in conventional systems are presumed to be through keyboard and mouse type input devices and a minimum screen size that enables users to interact with the user interface at a particular precision.

Menus for touch-enabled or gesture-enabled devices have special constraints and challenges. For example, such menus need to be touch and gesture enabled, and accessible with less precision than a mouse. The menus may not occupy extensive screen area and need to be flexible to changes in available screen area (e.g., landscape/portrait changes, different resolutions, appearance/disappearance of a virtual keyboard, etc.). The menus need to make use of features specific to touch devices (e.g., response to different gestures) and still work with a traditional mouse and keyboard. Users may tend to perform bursts of work on productivity applications on mobile devices—mainly read-only—not likely to be editing a long document for long hours on a mobile device. Thus, conventional menus are not geared to address this use model. They are also not comfortable and efficient in different contexts and/or positions (e.g., one finger/use of thumb/down on desk and typing). Furthermore, the command experience needs to be much richer for content creation and to provide a natural and delightful experience, which is expected with the more direct interaction that touch affords.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to one or more submenus associated with context based menus. A context based menu may include top level commands available for execution on selected textual and other content in a user interface. Each top level command displayed on the context based menu may be associated with additional executable commands. The presence of additional executable commands may be indicated by a submenu launcher. A submenu may be provided upon selection of the submenu launcher through a tap or swipe action in order to display the additionally executable subcommands associated with a top level command from the context based menu. The submenu may enable a user to select the available subcommands on the submenu using an additional interaction and upon selection the subcommand may be executed on the selected content.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIGS. 1A and 1B illustrate some example devices, where context based menus, submenus, and a launcher mechanism for such menus may be employed;

FIGS. 2A, 2B, and 2C illustrate some examples of context based submenu activation and use according to embodiments;

FIG. 3 illustrates some example submenu launcher configurations according to embodiments;

FIG. 4 illustrates an example disappearance of a submenu according to some embodiments;

FIG. 5A through 5E illustrate some example submenu configurations and their activation from a context based menu;

FIGS. 6A and 6B illustrate some example submenus according to other embodiments;

FIG. 7 is a networked environment, where a system according to embodiments may be implemented;

FIG. 8 is a block diagram of an example computing operating environment, where embodiments may be implemented; and

FIG. 9 illustrates a logic flow diagram for a process of launching submenus associated with context based menus according to embodiments.

### DETAILED DESCRIPTION

As briefly described above, a submenu may be provided upon detection of a user action including, but not limited to, a tap action, a swipe action, or a press-and-hold action on a submenu launcher associated with a top level command displayed on a context based menu in order to display additional subcommands associated with the top level command from the context based menu. The submenu may enable a user to select the available subcommands on the submenu using an additional interaction; and upon selection, the subcommand may be executed on the selected content.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents. While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

According to embodiments, a touch-enabled or gesture-enabled menu refers to context based command menus that make use of features specific to touch or gesture enabled computing devices, but may also work with a traditional mouse and keyboard. Context based menus are used to provide quick access to commonly used commands while viewing or editing documents, emails, contact lists, other communications, or any content (e.g., audio, video, etc.). Context based menus may appear as part of a user interface's regular menu, in a separate viewing pane (e.g., a window) outside or inside the user interface, and so on. Typically, context based menus present a limited set of commands for easy user access based on the context of currently displayed or selected content, device or applications capabilities, or other factors, but additional submenus may be presented upon user selection. Commonly used context based menus may appear over the viewed document.

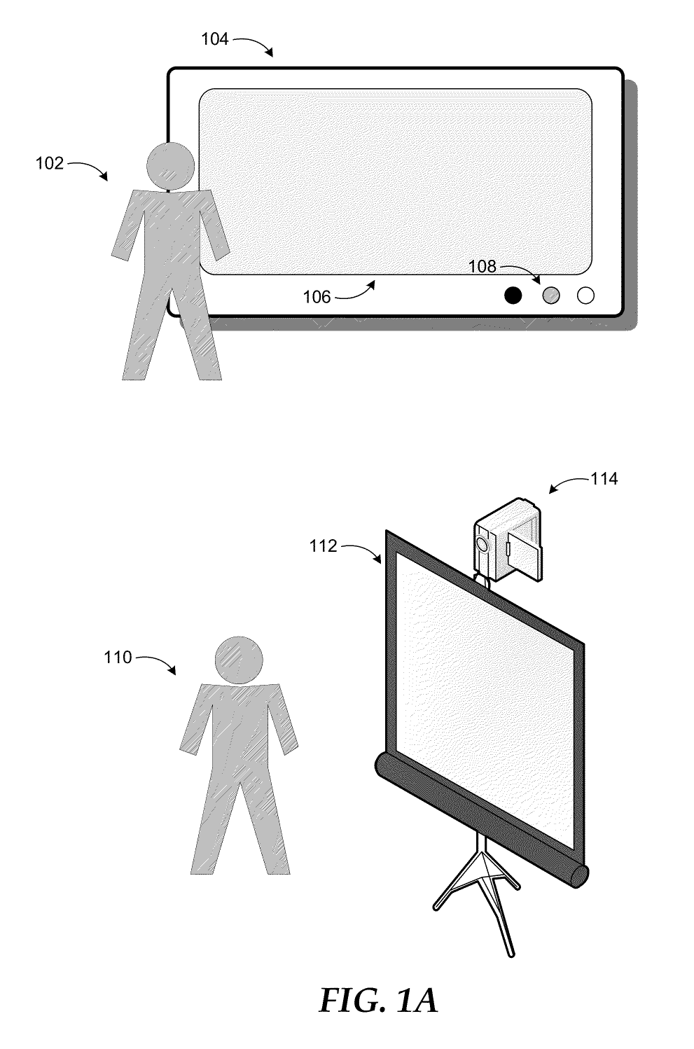

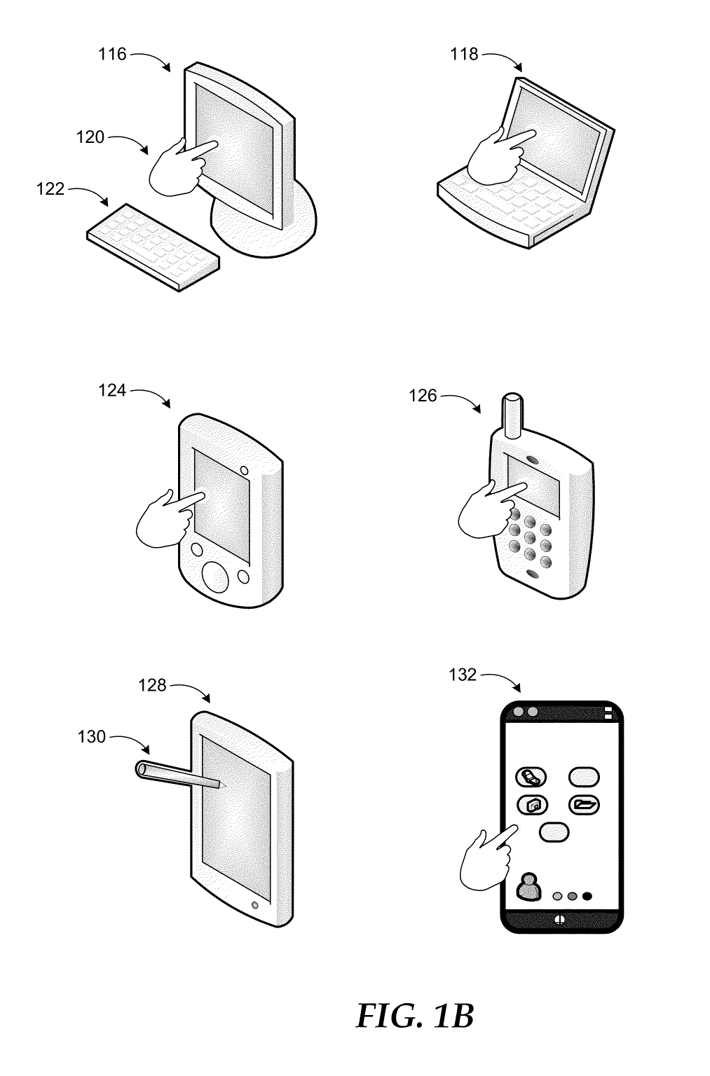

FIGS. 1A and 1B illustrate some example devices, where context based menus, submenus, and a launcher mechanism for such menus may be employed. As touch and gesture based technologies are proliferating and computing devices employing those technologies are becoming common, user interface arrangement becomes a challenge. Touch and/or gesture based devices, specifically portable devices, tend to have smaller screen size, which means less available space for user interfaces. For example, in a user interface that enables editing of a document (text and/or graphics), in addition to the presented portion of the document, a virtual keyboard may have to be displayed further limiting the available space (“real estate”). Thus, in such scenarios, providing a full control menu may be impractical or impossible. Embodiments are directed to a launcher mechanism for activating a dynamic touch or gesture enabled, context based menu.

As mentioned above, smaller available display space, larger content, and different aspect ratios make conventional menus impractical. Existing touch-based devices such as tablet PCs and similar ones are typically directed to data consumption (i.e., viewing). On the other hand, commonly used applications such as word processing applications, spreadsheet applications, presentation applications, and comparable ones are directed to creation (generating and editing documents with textual, graphical, and other content). Currently available context based menus are either invisible most of the time or they block the content when they are visible. A context based menu according to some embodiments may be provided dynamically based on presented content and available space and activated through a launcher mechanism that provides ease of use without usurping much needed display area.

Referring to FIGS. 1A and 1B, some example devices are illustrated, where a touch or gesture enabled, context based menu may be provided through activation by a launcher mechanisms according to embodiments. Embodiments may be implemented in other devices as well, with varying form factors and capabilities.

Device 104 in FIG. 1A is an example of a large size display device, where a user interface may be provided on screen 106. Functionality of various applications may be controlled through hardware controls 108 and/or soft controls such as a touch or gesture enabled menu displayed on screen 106. A user may be enabled to interact with the user interface through touch actions or gestures (detected by a video capture device). A launcher indicator may be presented at a fixed location or at a dynamically adjustable location for the user to activate the touch or gesture enabled menu. From within a context based menu, other submenus may be activated and displayed in place of the parent menu or in a vicinity of the parent menu concurrently. Examples of device 104 may include public information display units, large size computer monitors, and so on.

Device 112 in FIG. 1A is an example for use of a gesture based menu to control functionality. A user interface may be displayed on a screen or projected on a surface and actions of user 110 may be detected as gestures through video capture device 114. The user's gestures may activate a context enabled menu through a launcher indicator displayed on the device 112.

FIG. 1B includes several example devices such as touch enabled computer monitor 116, laptop computer 118, handheld computer 124, smart phone 126, tablet computer (or slate) 128, and mobile computing device 132, which may be used for computing, communication, control, measurement, and a number of other purposes. The example devices in FIG. 1B are shown with touch activation 120. However, any of these and other example devices may also employ gesture enabled activation of context based menus through a launcher indicator. In addition, tools such as pen 130 may be used to provide touch input. A launcher indicator and a touch or gesture enabled, context based menu may be controlled also through conventional methods such as a mouse input or input through a keyboard 122. Furthermore, other mechanisms such as an optically captured gesture input, a voice input, a mechanically captured gesture input, and/or a pen input may also be used to control a context based menu and associated submenus.

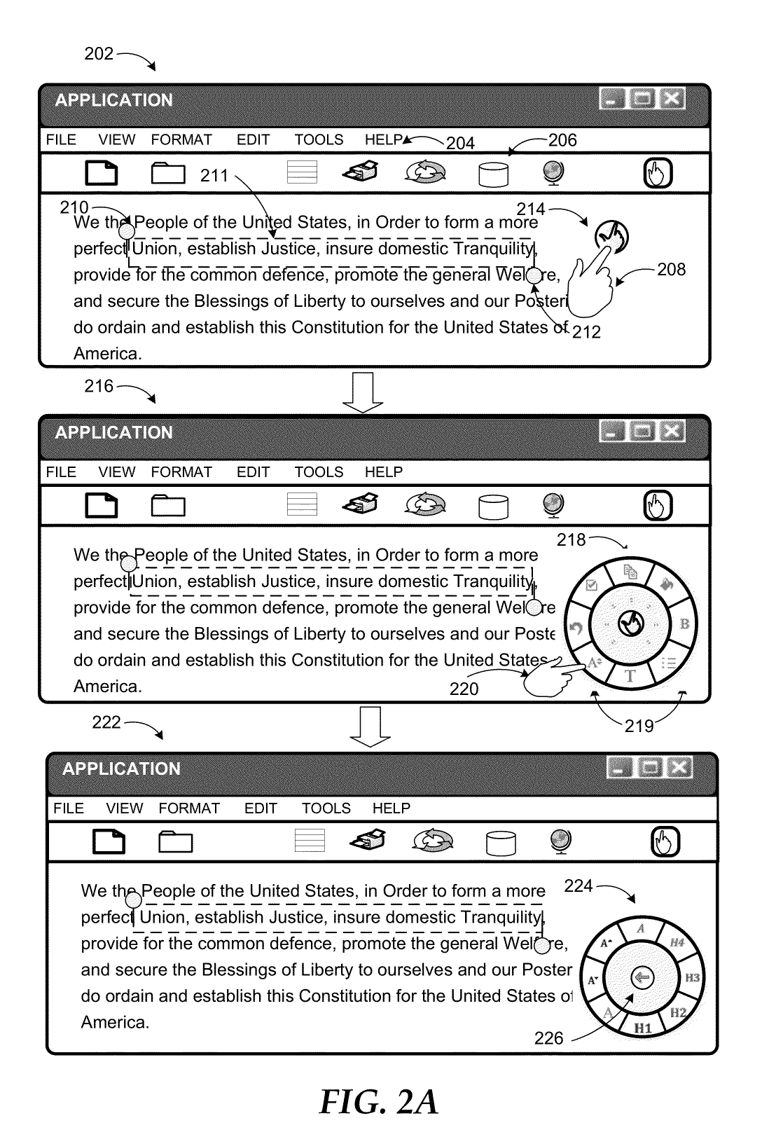

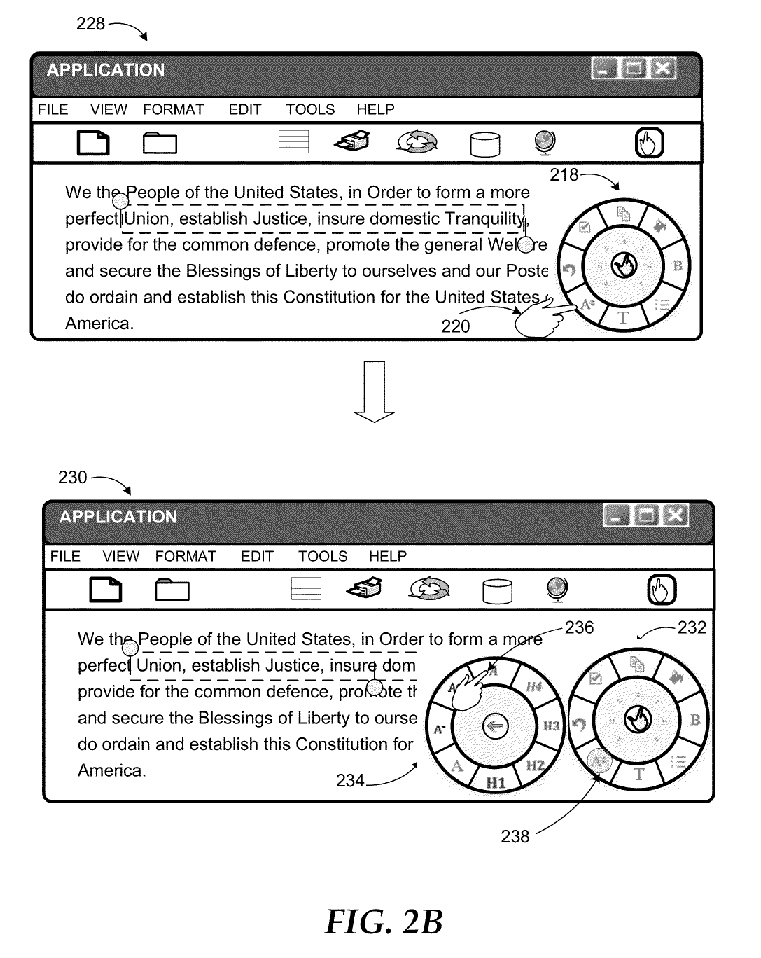

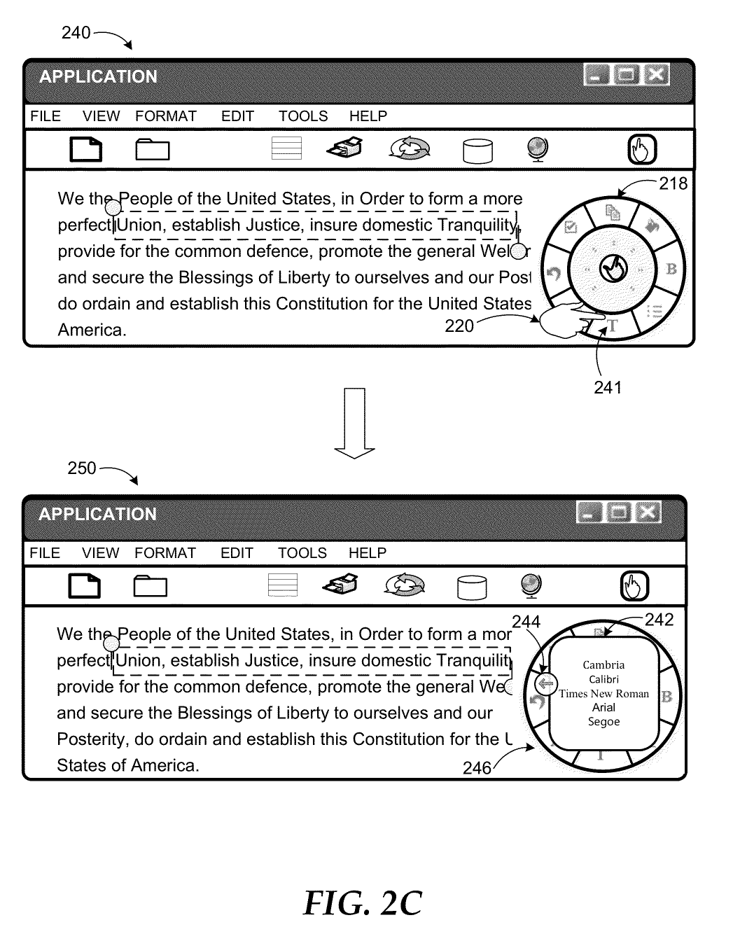

FIGS. 2A, 2B, and 2C illustrate some examples of context based submenu activation and use according to embodiments. A context based menu and associated submenus according to embodiments can appear close to a focus point (insertion point or selection), enable efficient invocation and/or use, allow commands to be scoped by context, provide increased scan ability (e.g., through a radial shape), allow a fast learning curve for first time users, and enhance user experience. Such a menu may be implemented in any application that enables content to be viewed and/or edited, as well as in operating system user interfaces.

The example configurations of submenus associated with context based menus in FIG. 2A through 2C are illustrated on example user interfaces, each of which include textual menus 204, graphic command icons 206 and textual and/or graphic content. A launcher indicator for enabling activation of context based menus may be employed on any user interface with any type of content with or without other types of menus. Referring to user interface 202, a launcher indicator 214 may be used in the vicinity of selected textual content 211 between selection handles 210 and 212 on the user interface. The launcher indicator 214 may serve as the launch point for the context based menu and quick access, through marking menu gestures, to top level commands displayed on the context based menu. A touching, swiping, pressing and holding, dragging/sliding or similar action may serve as activation for the underlying context based menu. Keyboard, mouse, touch, gesture, pen input, voice commands are some example input mechanisms that may be used in conjunction with the context based menu.

User interface 216 illustrates activation of a touch or gesture enabled context based menu 218 through the launcher indicator 214. The launcher indicator 214 associated with the selected textual content 211 may be selected through a tapping action or a swiping action. Upon selection of the launcher indicator 214, the context based menu 218 may appear on user interface 216, while the launcher indicator 214 may disappear or may be shown at the center of the context based menu as a context indicator (e.g., level of menu or return to previous menu indicator). The context based menu 218 may employ a hub & spoke interaction at the top level, and hub & spoke and/or dial interactions may be enabled at submenu levels. The context based menu may be presented in any form including, but not limited to a radial/circular shape shown in FIG. 2A-2C.

The context based menu 218 may be a parent context based menu including top level commands available for execution on the selected textual content 211. The commands may appear as segments of the context based menu 218 as the spokes in a hub and spoke configuration. In an example embodiment, the context based menu 218 may be a text selection context based menu for displaying commands available for executing on the selected textual content 211. Some available executable commands on the text selection context based menu may include, for example, copy, font color, bold, bullets and numbering, font size, font style, undo, and tags.

In a system according to embodiments, the context based menu 218 may display one or more commands or links to one or more submenus, each of which may include several additional executable commands and options. To navigate to the submenu, a tap or swipe action 220 may be received on one of the items displayed on the context based menu 218. An action to navigate to the submenu may also include a press and hold action on the item.

User interface 222 illustrates a submenu 224 associated with a particular item displayed on the context based menu 218. As demonstrated on user interface 216, a user may perform the tap or swipe action 220 on a submenu launcher item 219 associated of the context based menu 218. The submenu launcher item 219 may indicate visually that additional commands are available for the command, and selection of the submenu launcher may navigate to the submenu 224 associated with the selected item. For example, the user may select an item associated with the font size and style command on the context based menu 218 in order to navigate to the submenu containing additional font size and style commands.

Upon selection of the submenu launcher 219 associated with the font size and style command on the context based menu 218, the submenu 224 associated with the font size and style command may be launched on the user interface 222. The submenu 224 may launch and appear on the user interface 222 in place of the parent context based menu 218, and the parent context based menu 218 may disappear from display on the user interface 222. The submenu may be presented in any form including, but not limited to, a radial/circular shape shown in FIG. 2A, and may employ a hub & spoke interaction and/or dial interactions.

The submenu 224 associated with the selected font size and style command may display additional executable commands associated with font size and style, and the additional commands may appear as segments of the submenu 224. The submenu 224 may be configured to enable a user to execute the available commands on the submenu using an additional tap, swipe, or press and hold actions. If more commands are available than those displayed on the submenu 224, additional submenu launchers (e.g., an ellipsis item) may be displayed on the submenu for indicating additional available options. Selection of the submenu launchers on the submenu may operate to navigate to a secondary submenu. The user may perform a touch action, such as a tap or swipe action on a selected command on the submenu, in order to execute the command. The submenu 224 may additionally display a back button 226, which may be selected using a touch based interaction in order to navigate from the submenu 224 back to the parent context based menu 218.

User interfaces 228, 230, 240 and 250 in FIG. 2B and FIG. 2C illustrate additional example configurations of submenus associated with the context based menu. On user interface 228 of FIG. 2B, the user may select (220) to navigate to the submenu associated with the font size and style command on the context based menu 218. In response to the selection to navigate to the submenu, the submenu 234 associated with the font size and style command may be launched on the user interface 230. According to example embodiments, the submenu 234 may launch and appear on the user interface 222 next to the parent context based menu 232 such that the parent context based menu 232 remains visible to the user on the user interface 230. In some cases, the menus may be overlapping. For example, the back arrow of submenu 234 may be centered on the font size button 238; context based menu 232 may be grown and then submenu 234 positioned on top of context based menu 232. The overlap may be based on one or more of a location of user contact on the user interface, an available display area, a size of the submenu, and/or a size of the context based menu. As described above, the submenu may be presented as a radial/circular shape shown in FIG. 2, and may employ a hub & spoke interaction and/or dial interactions. The submenu 234 associated with the selected command may display additional executable commands, e.g. the font size and style command selected on user interface 228.

Additionally, the parent context based menu 232 may be configured to indicate which item was selected on the parent based menu for navigating to the submenu 234. For example, on user interface 228, the user may select to navigate to the submenu associated with the font size and style options on the context based menu 218. When the submenu 234 is displayed on user interface 230 next to the parent context based menu 232, the selected item—i.e. the font size and style item—may appear differently to indicate that it was the selected item. For example, the selected item may appear highlighted 238, magnified, shaded, or similarly marked for indicating that it was selected item for the displayed submenu 234.

On user interface 240 of FIG. 2C, an action 220, such as tapping or swiping, may be received to navigate to the submenu associated with the font command 241 on the context based menu 218. In response to the selection to open the submenu, the submenu 242 associated with the font command may be launched on the user interface 250. According to example embodiments, the submenu 234 may launch and appear on the user interface 222 on top of or overlapping with the parent context based menu 246 such that the parent context based menu 246 may remain partially visible to the user on the user interface 250, and the submenu 242 may be displayed in the foreground for enabling the user to select the additional commands available on the submenu 242.

As described above, the submenu may be presented as a radial/circular shape shown in FIG. 2. In additional embodiments, the submenu 242 may be optionally presented as a textual submenu when text is a better representation for items. The configuration of the textual submenu may be optimized for text instead of icons, and may be rectangular, for example, rather than radial. For example, the available fonts may be better represented as a list, and the submenu 242 may be presented as a list configuration as opposed to a radial configuration. The submenu 242 may additionally display a back button 244 which may be selected in order to navigate from the submenu 242 back to the parent context based menu 218. For example, upon selection of the back button 244, the submenu 242 may disappear from its position overlapping the parent context based menu 246 leaving only the parent context based menu 246 visible on the user interface 230.

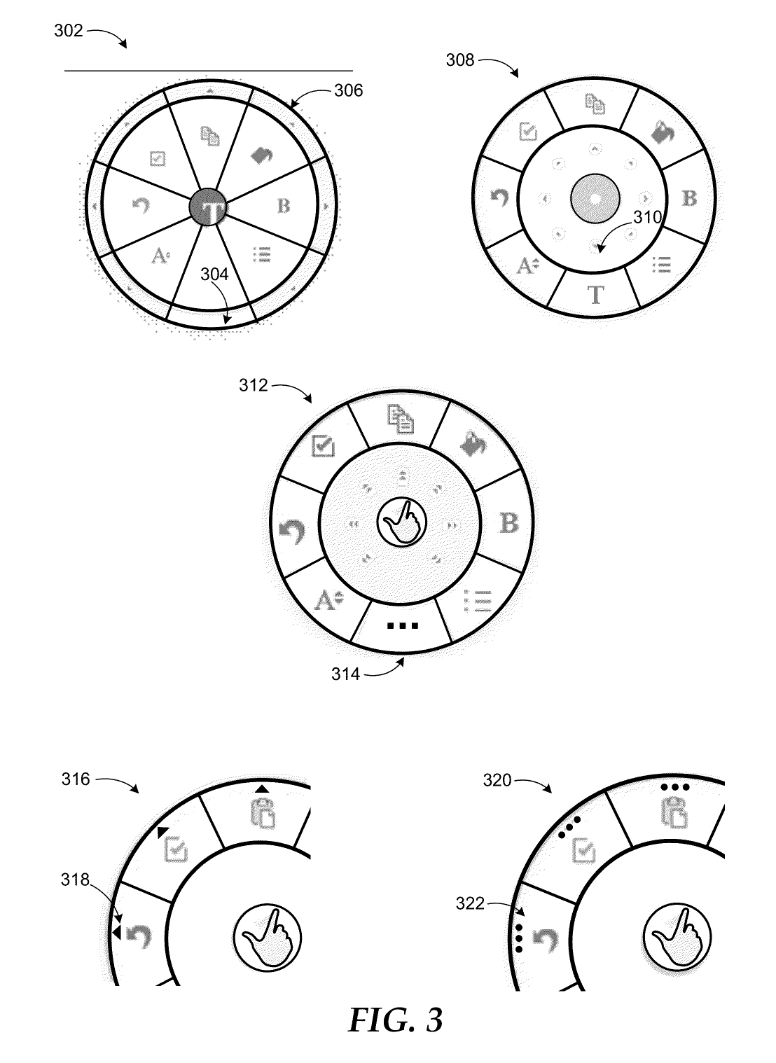

FIG. 3 illustrates some example submenu launcher configurations according to embodiments. According to some embodiments, parent context based menus 302, 308, 312, 316 and 320 are examples of context based menus including top level commands available for executing on selected textual or other selected content on a user interface. As described above in conjunction with FIG. 2A-2C, the available commands may appear as segments of or along the edges of the context based menu. In a system according to embodiments, each command displayed on the context based menu 218 may include several additional executable commands and options. These additional executable commands may be presented in a submenu associated with the parent or top level items from the context based menu.

In order to indicate to a user that additional executable commands may be available for a command displayed on the parent context based menu, submenu launchers may be displayed on the parent context based menu. The user may perform the tap or swipe action on the submenu launcher associated with a particular command on the context based menu in order to navigate to the submenu for executing the additional available commands.

As demonstrated by context based menu 302, the submenu launchers may appear at the outside edges 306 of the radial context based menu at the same angle as the command with which the submenu launcher is associated. Additionally, as demonstrated by context based menu 308, the submenu launchers may appear near the center (310) of the radial context based menu at the same angle as the command with which the submenu launcher is associated. As also demonstrated by context based menu 302, if a top level command is not available to complete the context based menu, the command position may remain empty 304. For example, the context based menu may be configured to display eight top level commands, and if only seven top level commands are available for a selected content, then the eighth position may remain empty 304.

Context based menu 312 further demonstrates the use of an ellipsis 314 in place of a command position. The ellipsis 314 may be utilized in order to indicate that additional top level commands may be available for selected content. For example, the context based menu may be configured to display eight top level commands, and if more than eight top level commands are available for a selected content, then the eighth position may display an ellipsis 314. Selection of the ellipsis 314 may operate to display a submenu with additional available top level commands. Selection of the ellipsis or any of the other sub-menu launchers may also launch other user interfaces such as a task pane, a bar across the edge of the screen, a dialog box, etc.

Context based menus 316 and 322 also demonstrate example configurations for submenu launchers and for indicating the availability of submenus associated with the top level commands. As shown in context based menu 316, small icons 318 may appear next to each available top level command in order to indicate the availability of additional commands, and the user may perform a touch action on the command itself to navigate to the submenu. Additionally, as shown in context based menu 320, the submenu launcher may be an ellipsis 322 or other icon for indicating the availability of additional commands associated with the displayed command upon selection of the command. A number of other icons may be employed to represent the submenu launcher for indicating the availability of additional commands and for navigation to the corresponding submenu.

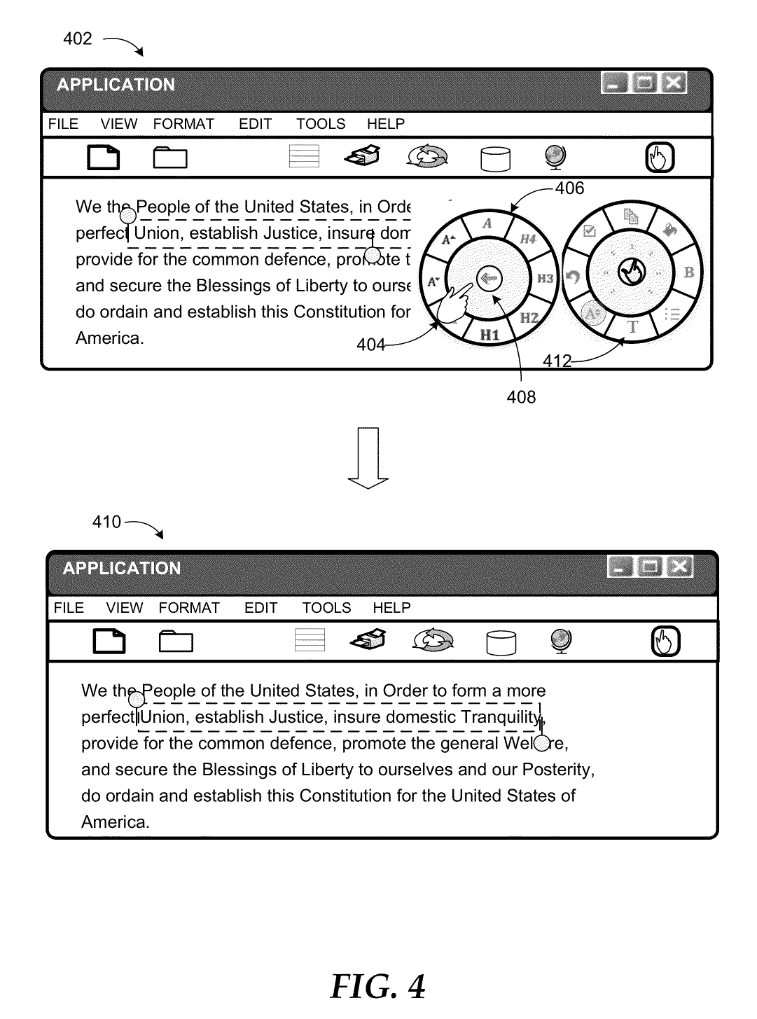

FIG. 4 illustrates an example disappearance of a submenu according to some embodiments. As shown on user interface 402, a submenu 406 according to embodiments may be invoked in response to selection of a submenu launcher associated with a top level command on a context based menu 412. The submenu 406 may additionally display a back button 408, which may be selected by a user action 404 in order to navigate from the submenu 406 back to the parent context based menu 412.

For example, upon selection of the back button 408, both the submenu 406 and parent context based menu 412 may disappear from view and the user interface 410 may revert to the original display in which it displays only the selected content. In a scenario where the submenu 406 appears next to the parent context based menu 412 or overlapping the parent context based menu 412, upon selection of the back button 408, the submenu 406 may disappear leaving only the parent context based menu 412 visible on the user interface. In a scenario where the submenu 406 may replace the parent context based menu 412, upon selection of the back button 408, the submenu 406 may disappear and be replaced by the original parent context based menu 412 on the user interface. Other events that may lead to disappearance of the submenu 406 may include tapping elsewhere on the user interface, scrolling a page, zooming in or out, entering new content (e.g., typing), moving to another user interface on the display, etc. Furthermore, execution of particular commands displayed on submenu 406 may also result in the disappearance of submenu 406 (e.g., execution of “copy” command). The disappearance, as well as the appearance, of the submenus may be in an animated fashion according to some embodiments.

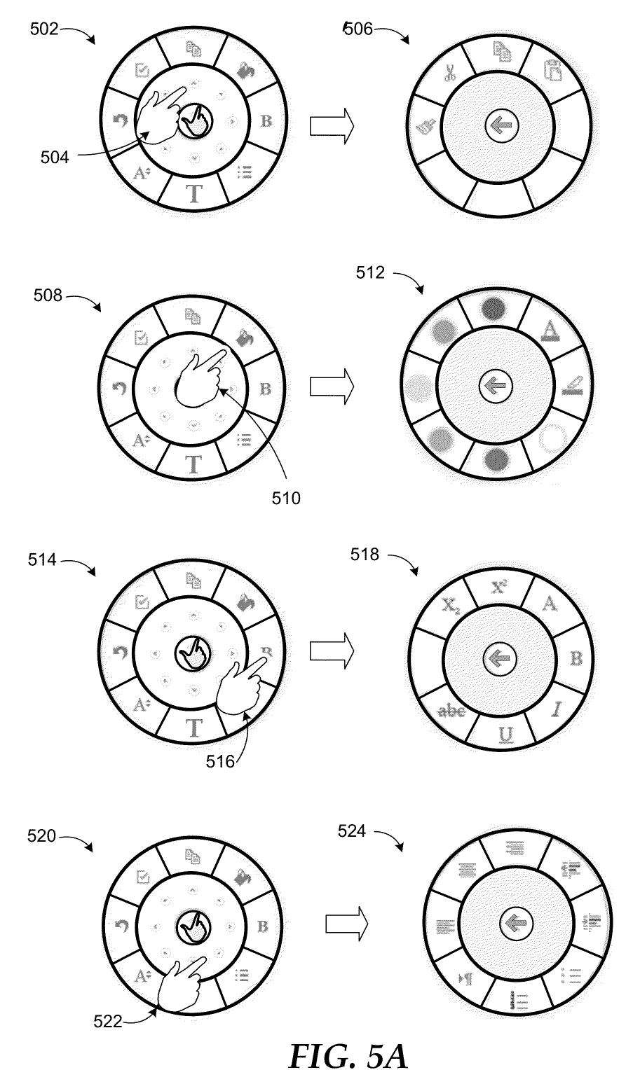

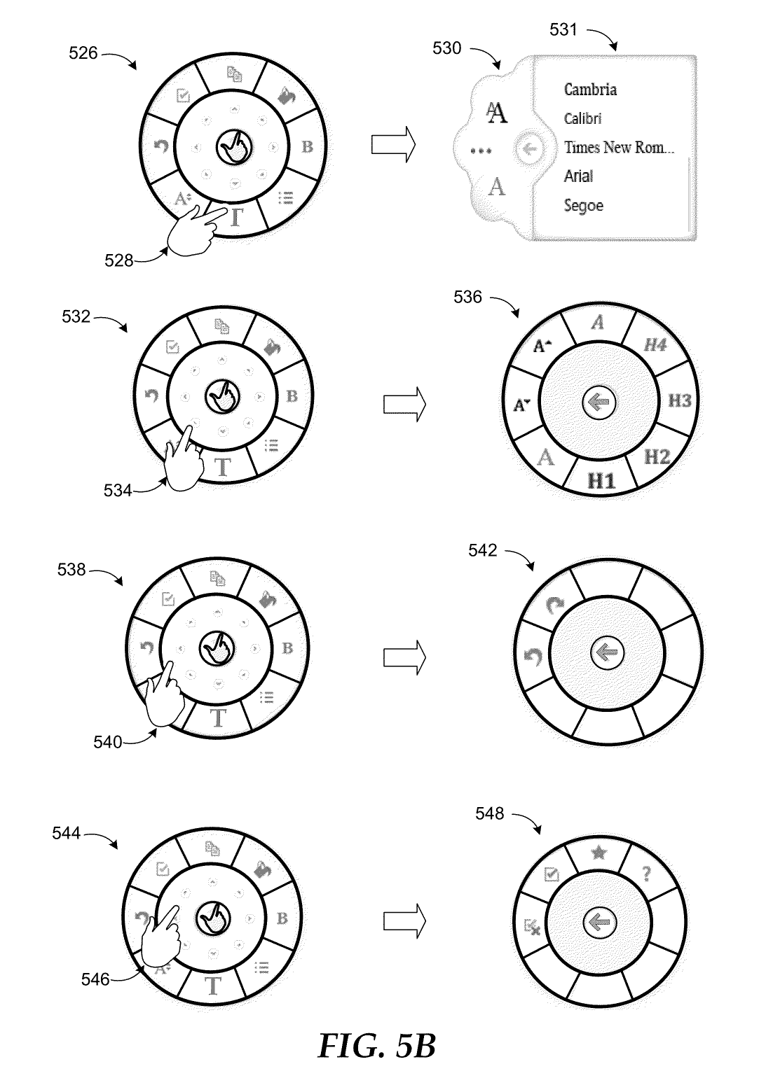

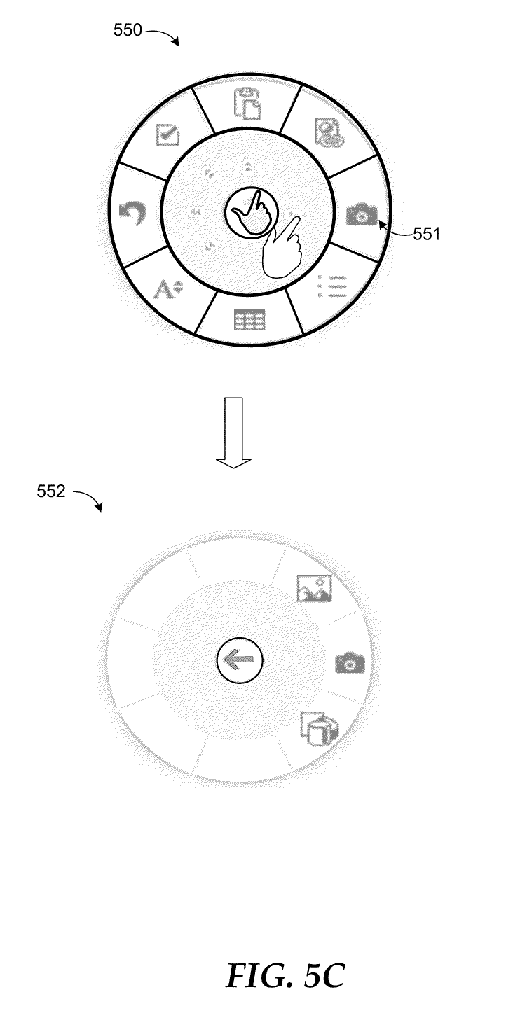

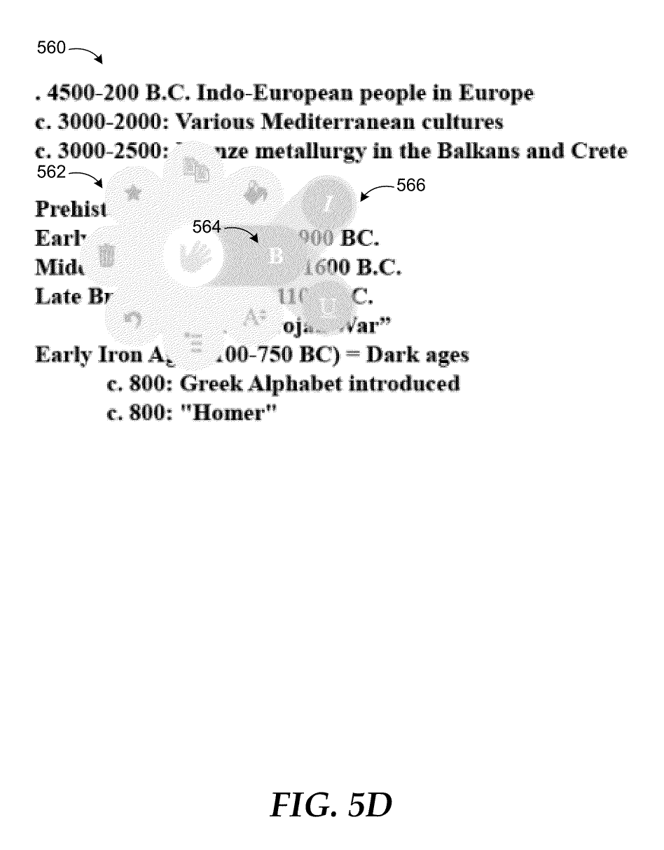

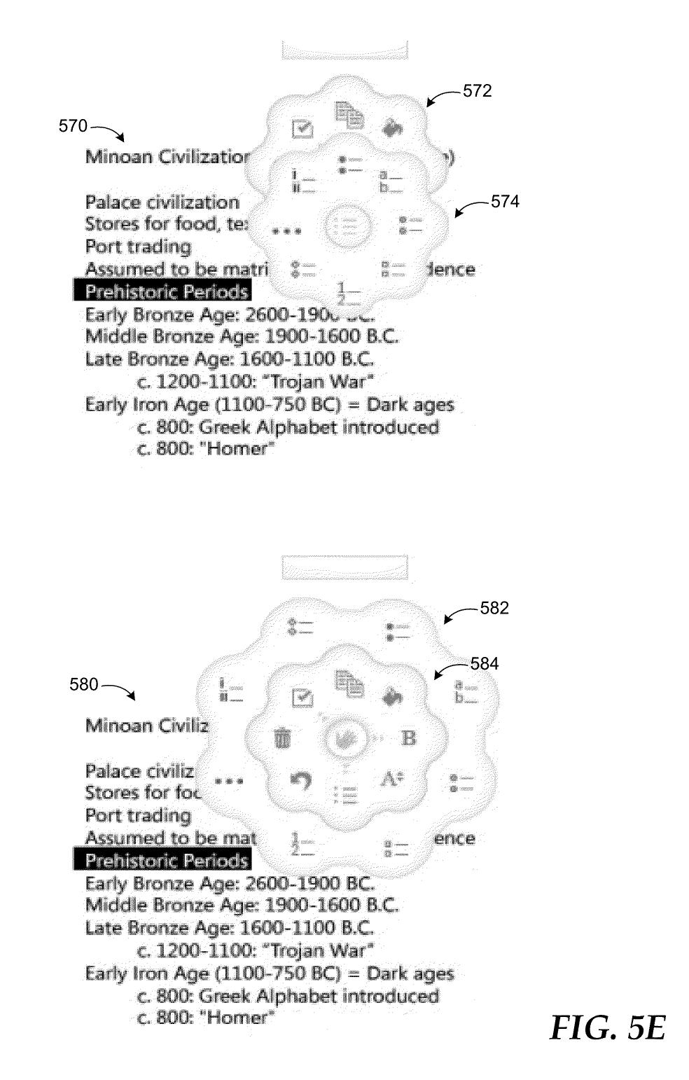

FIG. 5A through 5E illustrate some example submenu configurations and their activation from a context based menu. According to some embodiments, parent context based menus 502, 508, 514, 520, 526, 532, 538 544, and 550 are examples of context based menus including top level commands and links to submenus. In a system according to embodiments, the parent context based menu and associated submenus may be organized in a hierarchy, such that the parent context based menu may include top level items that represent a category of executable actions or links to further executable actions. The submenu associated with each top level item may include lower hierarchy commands or subcommands that are included in the category of executable actions at the top level. Additionally secondary, tertiary, etc. submenus may contain further lower level commands within the categorical hierarchy of executable commands. In some examples, a top level item associated with a submenu may be a Most Recently Used (MRU) or a Most Frequently Used (MFU) of the items in the submenu. For example, in a color picker submenu, the top level item in the parent context based menu calling the color picker submenu may reflect the last color selected within the submenu.

In an example embodiment, the parent context based menu 502 may be a text selection context based menu for displaying commands available for executing on the selected textual content. Some available executable commands on the text selection context based menu may include, for example, copy, font color, bold, bullets and numbering, font size, font style, undo, and tags. A tap or swipe based interaction on the executable commands and/or the submenu launchers corresponding to each available executable command may navigate to the submenu associated with the selected item. The following table indicates example top level items for the text selection context based menu, the position of the items on the context based menu, whether the items have a submenu and thus a corresponding submenu launcher, and the actions associated with selection of the items.

TABLE 1
Example items and actions associated with a top level context based menu

| | Command | Launches | |
|---|---|---|---|
| Position | Description | Submenu | Default Action |
| 1 | Copy | Yes | Copy the current |
| | | | selection. |
| 2 | Font and Highlight | Yes | Apply the last color |
| | Color | | selected (either font |
| | | | or highlight) to the |
| | | | current selection. |
| 3 | Bold | Yes | Bold the current |
| | | | selection. |
| 4 | Bullets and | Yes | Apply the default |
| | Numbering | | bullet format to the |
| | | | current selection. |
| 5 | ellipsis | Yes | Open submenu |
| 6 | Font Size | Yes | Apply the last font |
| | | | size or style |
| | | | selected to the |
| | | | current selection. |
| 7 | Undo | No | Undo the last |
| | | (no associated | action. |
| | | submenu) | |
| 8 | Tags | Yes | Apply the To Do |
| | | | tag. |

According to some embodiments, submenus 506, 512, 518, 524, 530, 536, 542, 548, and 552 are examples of submenus associated with top level commands on the context based menu available for executing on selected textual or other selected content in a user interface. The submenu associated with context based menu 502 demonstrates a copy submenu 506 associated with the copy top level item selected by the user (504) on the context based menu 502. The following table indicates the additional available commands associated with the copy top level item, the position of the commands on the copy submenu 506, a description of the commands, and the action(s) associated with selection of the commands.

TABLE 2
Example items and actions associated with a context based submenu

| Position | Command Description | Action |
|---|---|---|
| 1 | Copy | Copy the current selection. |
| 2 | Paste | Paste over the current |
| | | selection. |
| 7 | Format Painter | Switch into format painter |
| | | mode. |
| 8 | Cut | Cut the current selection. |

A position of an item on a context based menu or submenu may be one of two things: it may be a statically identified position, where the items on the menu start at position “1” (at 12 o'clock location) and the items are positioned clockwise around the menu ending at “8”. Alternatively, “1” may start where the user enters into the submenu. For example, in the case of the “bold” submenu, position “1” may actually be at 3 o'clock location but in the case of “undo” submenu, position “1” may be at 9 o'clock location. This way, the top level command may be moved around without having to rewrite the submenu.

The submenu associated with context based menu 508 demonstrates a color submenu 512 associated with the color top level item 510 selected by the user on the context based menu 508. The following table indicates the additional available commands associated with the color top level item, the position of the commands on the color submenu 512, a description of the commands, and the action(s) associated with selection of the commands.

TABLE 3
Example items and actions associated with a context based submenu

| Position | Command Description | Action |
|---|---|---|
| 1 | Red | Apply Red Theme Color to |
| | | font or highlight color. |
| 2 | Font color | Apply next colors selected to |
| | | font. |
| 3 | Highlight color | Apply next colors selected to |
| | | text highlight. |
| 4 | Black | Apply Black Theme Color to |
| | | font or highlight color. |
| 5 | Blue | Apply Blue Theme Color to |
| | | font or highlight color. |
| 6 | Green | Apply Green Theme Color to |
| | | font or highlight color. |
| 7 | Yellow | Apply Yellow Theme Color |
| | | to font or highlight color. |
| 8 | Orange | Apply Orange Theme Color |
| | | to font or highlight color. |

The submenu associated with context based menu 514 demonstrates a bold submenu 518 associated with the bold top level item 516 selected by the user on the context based menu 514. The following table indicates the additional available commands associated with the bold top level item, the position of the commands on the bold submenu 518, a description of the commands, and the action(s) associated with selection of the commands.

TABLE 4
Example items and actions associated with a context based submenu

| Position | Command Description | Action |
|---|---|---|
| 1 | Superscript | Make the selected text a |
| | | superscript |
| 2 | Font | Select from list of fonts |
| 3 | Bold | Apply bold to the selected |
| | | text |
| 4 | Italic | Apply italic to the selected |
| | | text |
| 5 | Underline | Apply underline to the |
| | | selected text |
| 6 | Strikethrough | Apply strikethrough to the |
| | | selected text |
| 7 | <empty> | |
| 8 | Subscript | Make the selected text a |
| | | subscript |

As can be seen on submenu 518, not all available spaces on a submenu have to be filled. In the example submenu, there are seven commands displayed over eight available spaces. The submenu associated with context based menu 520 demonstrates a bullets submenu 524 associated with the bullets top level item 522 selected by the user on the context based menu 520.

As discussed previously, context based menus and submenus may be displayed in any shape or form including, but not limited to, a radial, a rectangular, a straight in-line, a curved in-line, and an irregular shape. Example context based menu 526 is a radial shape menu, where a text style item 528 is selected through a tap, swipe, or press and hold action. In response, submenu 530 in irregular shape is displayed with a text size increase/decrease item, a font selection item, and a ellipsis item indicating another level of submenu. Upon selection of the font selection item, a third level submenu 531 may be displayed providing a list of available fonts. The third level submenu 531 may be sliding list enabling the user to select a font among a larger list of fonts than the ones displayed.

The submenu associated with context based menu 532 demonstrates a font size and style submenu 536 associated with the font size and style top level item 534 selected by the user on the context based menu 534. The submenu associated with context based menu 538 demonstrates an undo submenu 542 associated with the undo top level item 540 selected by the user on the context based menu 538.

The submenu associated with context based menu 544 demonstrates a tags submenu 548 associated with the tags top level item 546 selected by the user on the context based menu 544. In an example embodiment, the context based menu 550 may display commands available for executing on the content at a selected insertion point. Some available executable commands on context based menu 550 may include, for example, paste, create hyperlink, insert image from camera, insert image from file, bullets and numbering, insert table, font size, undo, and tags. A tap or swipe based interaction on the executable commands and/or the submenu launchers corresponding to each available executable command may navigate to the submenu associated with the selected command. The following table indicates example top level commands for the insertion point context based menu, the position of the command on the context based menu, whether the command has a submenu and thus a corresponding submenu launcher, and the actions associated with selection of the command.

TABLE 5
Example items and actions associated with a top level context based menu

| | Command | Launches | |
|---|---|---|---|
| Position | Description | Submenu | Default Action |
| 1 | Paste | No | Paste over the current |
| | | | selection. |
| 2 | Create | No | Launches the Link dialog |
| | hyperlink | | |
| 3a | Insert image | Yes | Launches camera module (if |
| | from camera | | camera hardware installed) |
| | | | to take a picture and insert it |
| | | | into application |
| 3b | Insert image | Yes | Launches the file picker |
| | from file | | scoped to images. |
| 4 | Bullets and | Yes | Apply the default bullet |
| | Numbering | | format to the current |
| | | | selection. |
| 5 | Insert table | No | Inserts the default (e.g., 3 |
| | | | column × 2 row) table |
| 6 | Font Size | Yes | Apply the last font size or |
| | | | style selected to the current |
| | | | selection. |
| 7 | Undo | Yes | Undo the last action. |
| 8 | Tags | Yes | Apply the To Do tag. |

The submenu associated with the selection of image item 551 on context based menu 550 demonstrates an illustrations submenu 552. The following table indicates the additional available commands associated with the image top level item 551, the position of the commands on the illustrations submenu 552, a description of the commands, and the action(s) associated with selection of the commands. Illustrations submenu 552 may provide commands associated with charts, images, and other graphical content.

TABLE 6
Example items and actions associated with a context based submenu

| | Command | | |
|---|---|---|---|
| Position | Description | Tooltip | Default Action |
| 2 | Insert picture from | Insert | Launches the file picker |
| | file | Picture from | scoped to images. |
| | | File | |
| 3 | Insert image from | Insert | Launches camera module |
| | camera | Picture from | to take a picture and insert |
| | | Camera | it into application |
| 4 | Insert Shapes | Insert | Launches a gallery of the |
| | | Shapes | most commonly used |
| | | | shapes. |

FIG. 5D includes a context based menu 562 displayed over content 560. Upon selection of a top level font characteristic item (“B” bold) 564 on the context based menu, a partial submenu consisting of two other font characteristic commands (“I” italic and “U” underline) appears adjacent to the selected item as an extension of the context based menu. Thus, in some embodiments, submenus may appear as extensions of parent menus.

FIG. 5E illustrates two example configurations of submenus overlapping with their respective parent menus. In the first example, parent menu 572 is displayed over content 570. Upon selection of a list formatting item on the parent menu 572, submenu 574 providing various options for list or bullet formatting may be displayed partially overlapping with the parent menu 572. In the second example, submenu 582 is grown out of the parent menu 584 such that contents of both menus can be seen over the displayed content 580.

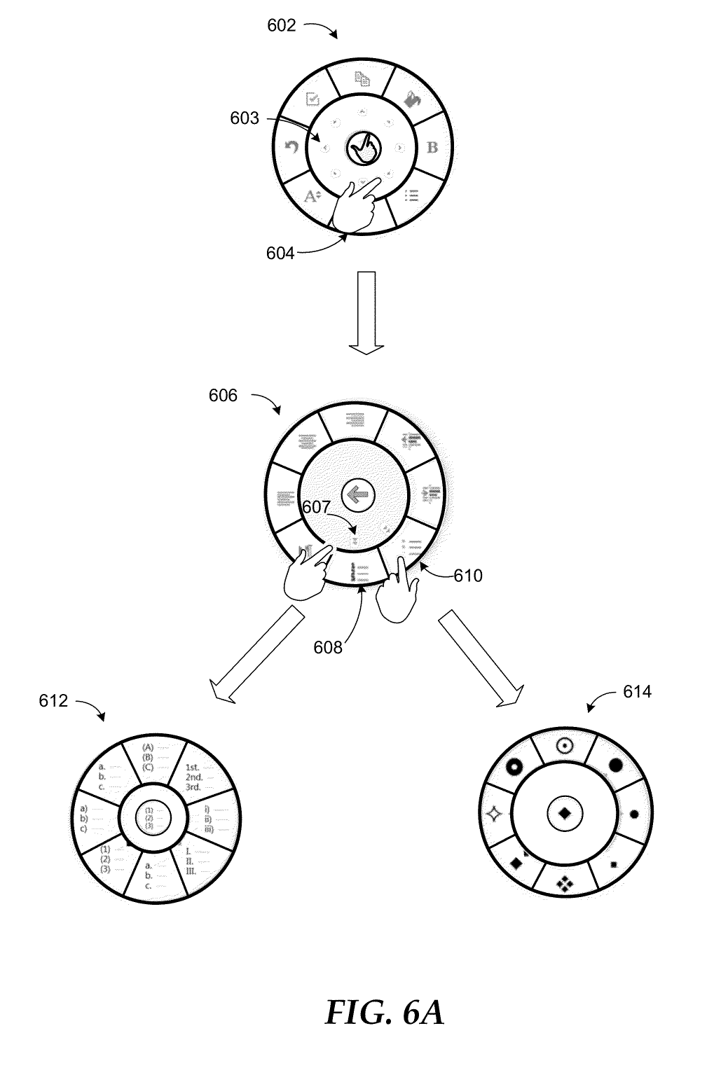

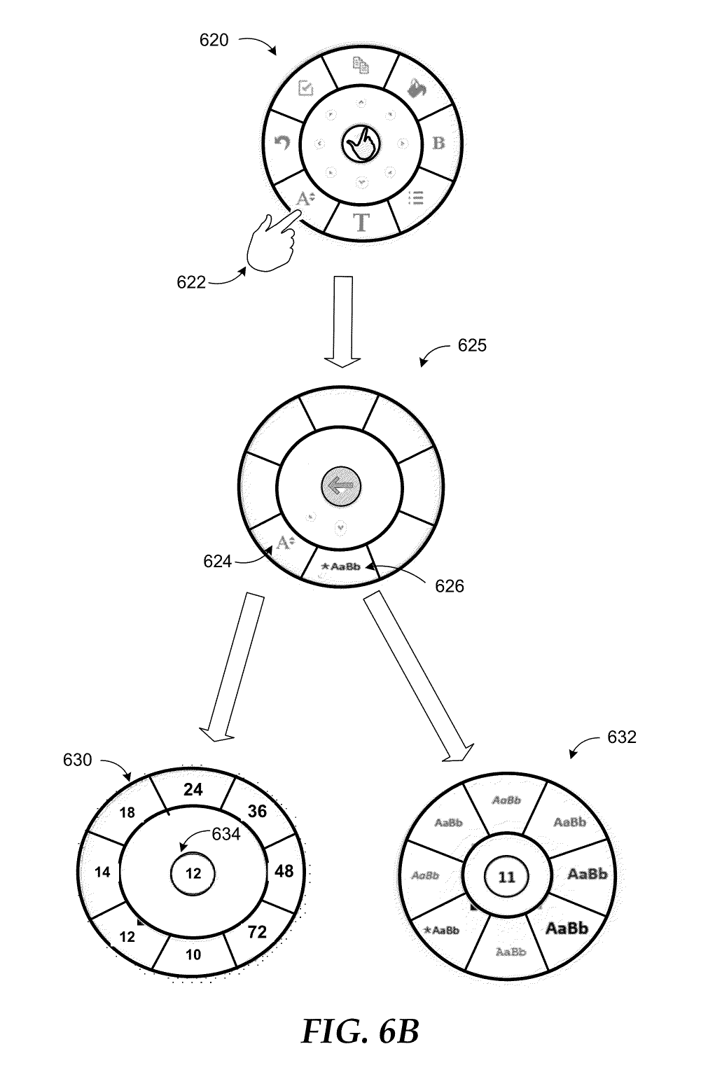

FIGS. 6A and 6B illustrate some example submenus according to other embodiments. In an example embodiment, top level context based menu 602 includes some of the top level items discussed previously. Small arrow icons 603 near a center of the menu for each top level item indicate the availability of additional commands/options in form of submenus. Upon selection of one of the items (604) through a tap or swipe action (e.g., from the center to an outer radius of the menu in direction of the selected item), submenu 606 may be displayed presenting 8 additional items. In the example of FIG. 6A, three of the items displayed on submenu 606 may be commands associated with paragraph alignment, two with indentation, one with text direction, and two items may be associated with bulleted or numbered lists.

Thus, small icons 607 near a center of the submenu 606 indicate the availability of additional submenus for items 608 and 610. Upon selection of bulleted lists item 610, third level submenu 614 may be displayed enabling a user to select among available bullet types. Upon selection of numbered lists item 608, third level submenu 612 may be displayed enabling the user to select among different numbered list options.

In some embodiments, each level of submenus may indicate further availability of submenus through icons near the center of the menu, along the edges of the menu, an ellipsis item, or other graphical/textual indicators. According to other embodiments, a selected item may be displayed at the center (or other suitable location depending on menu style, shape, form) of the submenu or indicated through a shading/highlighting/coloring scheme to emphasize to the user which item is currently selected (or was previously selected).

FIG. 6B demonstrates optional configurations for submenus and/or sub-submenus associated with top level commands on a parent context based menu. In the illustrated example, top level context based menu 622 includes some of the top level items discussed previously.

Upon selection of a font size and style item 622, submenu 625 is displayed with two items: font size selection item 624 and font style selection item 626. Upon selection of font size selection item 624, third level submenu 630 may be displayed presenting available font sizes for selection. The font sized may be selectable in a discrete manner (i.e., each displayed value is an option) or in a continuous manner (i.e., each displayed value is an example value, other values in between can be selected through a dial action). A currently selected font size may be displayed at the center 634 of the submenu 630. In other examples, the currently selected font size (or similar selection) may be displayed in a tooltip or in a selected form on a slider.

Upon selection of the font style item 626, font style submenu 632 may be displayed presenting available font styles. Selection among the available font styles may also be made through dial action or tap action. Since a size of the font may affect how a font looks on screen, the currently selected font size may also be displayed at the center of the font style submenu 632. In other embodiments, a submenu may combine selection functionality. For example, font size and style may be selected through the same submenu using the segments for one option (e.g., font style) and the center for another function (e.g., font size). In such a scenario, the font size selection at the center of the submenu may be through a rolling action (e.g., up and down arrows may be displayed to increase or decrease the font size.

The example launcher indicators, configurations, items, and context based menus depicted in FIGS. 1 through 6 are provided for illustration purposes only. Embodiments are not limited to the shapes, forms, and content shown in the example diagrams, and may be implemented using other textual, graphical, and similar schemes employing the principles described herein.

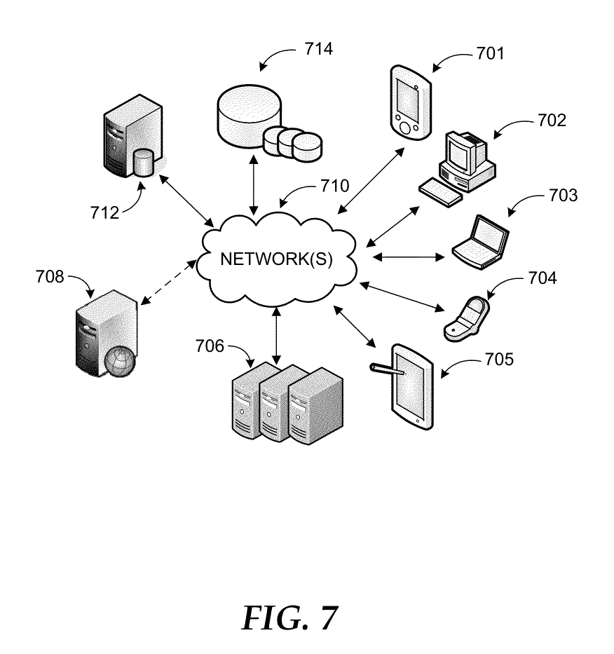

FIG. 7 is an example networked environment, where embodiments may be implemented. In addition to locally installed applications, such as application 822 discussed below, submenus associated with context based menus may also be employed in conjunction with hosted applications and services that may be implemented via software executed over one or more servers 706 or individual server 708. A hosted service or application may communicate with client applications on individual computing devices such as a handheld computer 701, a desktop computer 702, a laptop computer 703, a smart phone 704, a tablet computer (or slate), 705 (client devices') through network(s) 710 and control a user interface presented to users.

As discussed, a context based touch or gesture enabled menu may be used for controlling functionality provided by the hosted service or application. A submenu associated with the context based menu for displaying additional executable commands may be activated through submenu launcher indicator.

Client devices 701-705 are used to access the functionality provided by the hosted service or application. One or more of the servers 706 or server 708 may be used to provide a variety of services as discussed above. Relevant data may be stored in one or more data stores (e.g. data store 714), which may be managed by any one of the servers 706 or by database server 712.

Network(s) 710 may comprise any topology of servers, clients, Internet service providers, and communication media. A system according to embodiments may have a static or dynamic topology. Network(s) 710 may include a secure network such as an enterprise network, an unsecure network such as a wireless open network, or the Internet. Network(s) 710 may also coordinate communication over other networks such as PSTN or cellular networks. Network(s) 710 provides communication between the nodes described herein. By way of example, and not limitation, network(s) 710 may include wireless media such as acoustic, RF, infrared and other wireless media.

Many other configurations of computing devices, applications, data sources, and data distribution systems may be employed to provide a launcher mechanism for context based menus. Furthermore, the networked environments discussed in FIG. 7 are for illustration purposes only. Embodiments are not limited to the example applications, modules, or processes.

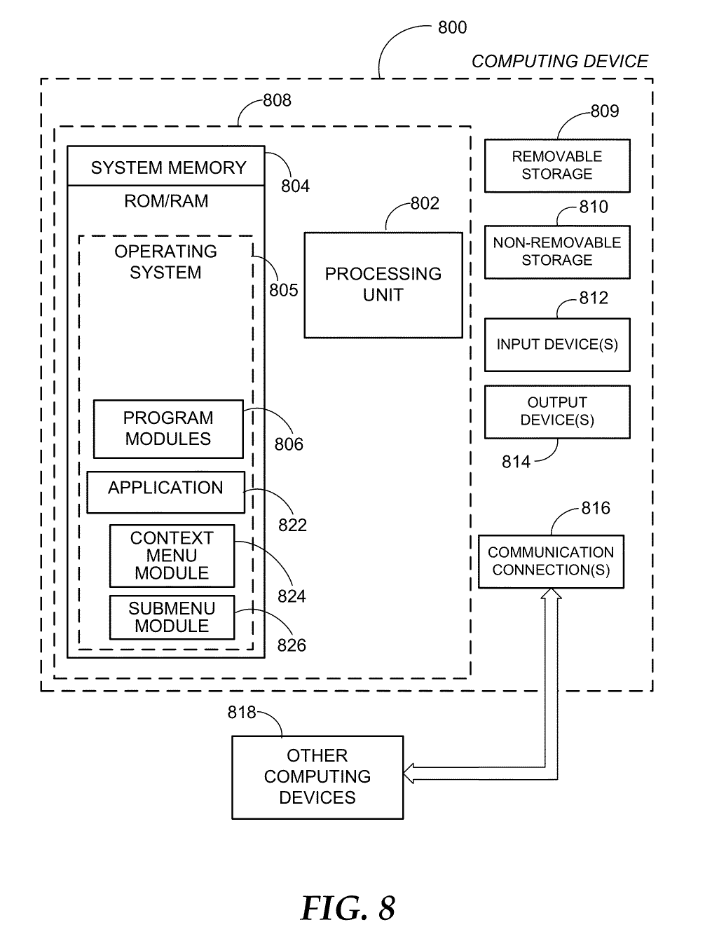

FIG. 8 and the associated discussion are intended to provide a brief, general description of a suitable computing environment in which embodiments may be implemented. With reference to FIG. 8, a block diagram of an example computing operating environment for an application according to embodiments is illustrated, such as computing device 800. In a basic configuration, computing device 800 may be any touch and/or gesture enabled device in stationary, mobile, or other form such as the example devices discussed in conjunction with FIGS. 1A, 1B, and 7, and include at least one processing unit 802 and system memory 804. Computing device 800 may also include a plurality of processing units that cooperate in executing programs. Depending on the exact configuration and type of computing device, the system memory 804 may be volatile (such as RAM), non-volatile (such as ROM, flash memory, etc.) or some combination of the two. System memory 804 typically includes an operating system 805 suitable for controlling the operation of the platform, such as the WINDOWS®, WINDOWS MOBILE®, or WINDOWS PHONE® operating systems from MICROSOFT CORPORATION of Redmond, Wash. The system memory 804 may also include one or more software applications such as program modules 806, application 822, context based menu module 824, and submenu module 826.

Context based menu module 824 may operate in conjunction with the operating system 805 or application 822 and provide a context based menu that can be interacted with through touch and/or gesture actions or conventional mechanisms such as keyboard entries, mouse clicks, pen inputs, and others, as discussed previously. Submenu module 824 may also launch a submenu associated with a selected command on the context based menu in response to a touch gesture interaction on a submenu launcher on the context based menu. This basic configuration is illustrated in FIG. 8 by those components within dashed line 808.

Computing device 800 may have additional features or functionality. For example, the computing device 800 may also include additional data storage devices (removable and/or non-removable) such as, for example, magnetic disks, optical disks, or tape. Such additional storage is illustrated in FIG. 8 by removable storage 809 and non-removable storage 810. Computer readable storage media may include volatile and nonvolatile, removable and non-removable media implemented in any method or technology for storage of information, such as computer readable instructions, data structures, program modules, or other data. System memory 804, removable storage 809 and non-removable storage 810 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer readable storage media may be part of computing device 800. Computing device 800 may also have input device(s) 812 such as keyboard, mouse, pen, voice input device, touch input device, an optical capture device for detecting gestures, and comparable input devices. Output device(s) 814 such as a display, speakers, printer, and other types of output devices may also be included. These devices are well known in the art and need not be discussed at length here.

Computing device 800 may also contain communication connections 816 that allow the device to communicate with other devices 818, such as over a wireless network in a distributed computing environment, a satellite link, a cellular link, and comparable mechanisms. Other devices 818 may include computer device(s) that execute communication applications, other directory or policy servers, and comparable devices. Communication connection(s) 816 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

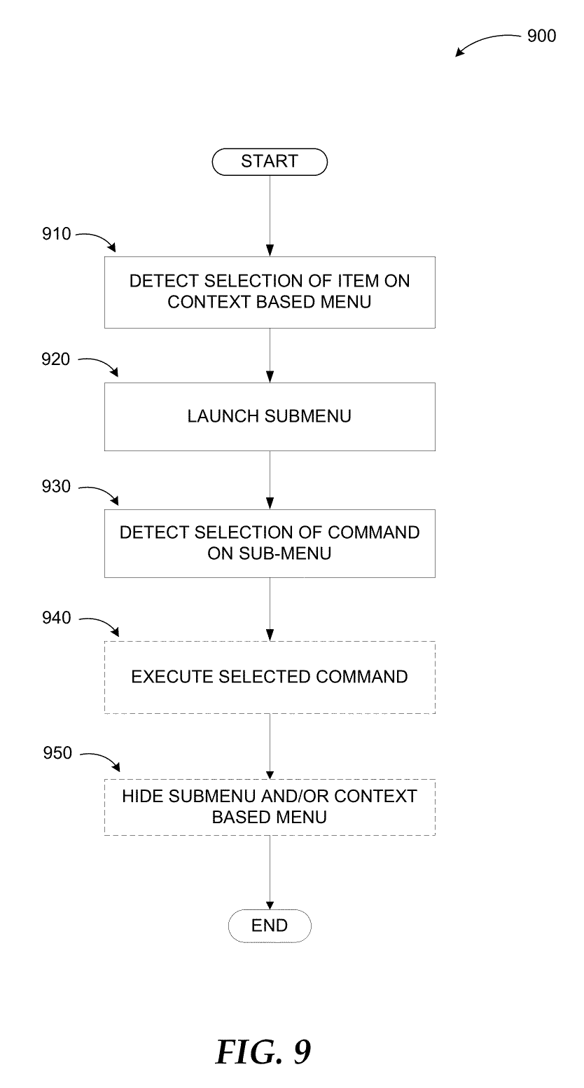

FIG. 9 illustrates a logic flow diagram for a process of launching submenus associated with context based menus according to embodiments. Process 900 may be implemented as part of an application or an operating system.

Process 900 begins with optional operation 910, where a context based menu may be displayed on a user interface associated with a selected portion of textual content or other displayed content. Context based menus may also be displayed in response to detection of an insertion point or activation of a user interface element. The context based menu may be a parent context based menu including top level commands available for execution on the selected content. Each top level item displayed on the context based menu may include several additional executable commands and options. These additional executable commands may be presented in a submenu associated with the top level command from the parent context based menu. At operation 920, a user may execute an interaction on one of the top level items displayed on the context based menu to navigate to the submenu. An interaction on one of the items may include a tapping gesture, a swiping gesture, and/or a press and hold on the item to navigate to the submenu.

At operation 930, the submenu associated with the selected item may launch and be displayed on the user interface. The submenu may be displayed in place of, next to, or overlapping with the context based menu. The submenu associated with the selected item may display additional executable commands associated with the top level item. The submenu may be configured to enable a user to execute the available commands on the submenu using an additional interaction, and at operation 940, the system may detect a user action to select a subcommand from the submenu.

If additional commands are available for the items displayed on the submenu, additional submenu launchers may be displayed on the submenu for indicating additional available commands, and the user may select the submenu launchers on the submenu to navigate to lower level submenus. At optional operation 950, the system may execute a selected subcommand. At operation 960, the submenu may additionally display a back button, which may be selected in order to hide the submenu from display such that the parent context based menu becomes visible again. Additionally, after execution of the subcommand, the submenu may become automatically hidden from display on the user interface, and optionally the context based menu as a whole may also be hidden. In some cases, execution of commands may even automatically navigate to another submenu. For example, on insertion of a table, a new submenu may be presented that includes the insert row/columns commands to be able to change the size of the table.

The operations included in process 900 are for illustration purposes. Presenting context based submenus according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for providing a submenu associated with context based menus, the method comprising:
in response to detecting one of a selection of a portion of displayed content on a user interface and an action on the user interface, presenting a context based menu that includes at least one from a set of a command and a link to a submenu;
in response to detecting selection of the link,
selecting a location for the submenu based on the selected portion of the displayed content, and
displaying the submenu presenting items that include at least one from a set of another command and a link to another submenu at the selected location; and
in response to a selection of an item on the submenu, one of executing the other command and displaying the other submenu.

2. The method of claim 1, wherein the action includes at least one from a set of: a tap action, a swipe action, and a press and hold action.

3. The method of claim 3, wherein the action is received through at least one from a set of: a touch input, an optically captured gesture input, a keyboard entry, a mouse click, a voice input, a mechanically captured gesture input, and a pen input.

4. The method of claim 1, further comprising:
displaying the submenu in place of the context based menu on the user interface, such that the context based menu disappears from display on the user interface.

5. The method of claim 1, further comprising:
displaying the submenu next to the context based menu on the user interface, such that the context based menu remains visible on the user interface.

6. The method of claim 1, further comprising:
displaying the submenu in an overlapping manner with the context based menu on the user interface, such that the context based menu remains partially visible on the user interface.

7. The method of claim 6, wherein the submenu and the context based menu are arranged to overlap based on at least one from a set of: a location of user contact on the user interface, an available display area, a size of the submenu, and a size of the context based menu.

8. The method of claim 1, wherein the context based menu and the submenu have one of a radial, a rectangular, a straight in-line, a curved in-line, and an irregular shape.

9. The method of claim 8, wherein the context based menu and the submenu have distinct shapes.

10. The method of claim 1, further comprising:
in response to one of: execution of a predefined command, a tap action away from the submenu, a selection of a back button displayed on the submenu, a scroll action, a zooming action, a selection of a different portion of displayed content, a new content entry, and selection of another user interface, hiding the submenu.

11. The method of claim 10, further comprising:
hiding the submenu such that one of:
the context based menu remains displayed,
the context based menu is also hidden, and
the submenu disappears in an animated fashion.

12. The method of claim 1, further comprising:
automatically selecting a layout of items displayed on the submenu based on a location of the selected link on the context based menu activating the submenu.

13. A computing device for providing a submenu associated with context based menus, the computing device comprising:
an input device;
a memory;
a processor coupled to the memory and the input device, the processor executing an application and causing a user interface associated with the application to be displayed on a screen, wherein the processor is configured to:
in response to detecting one of a selection of a portion of displayed content on a user interface, an insertion point, and an action on the user interface, present a context based menu that includes at least one from a set of a command and a link to a submenu;
in response to detecting selection of the link,
select a location for the submenu based on the selected portion of the displayed content and a layout of items to be displayed on the submenu based on a location of the selected link on the context based menu, and
display the submenu presenting items that include at least one from a set of another command and a link to another submenu at the selected location; and
in response to a selection of an item on the submenu, one of execute the other command and display the other submenu.

14. The computing device of claim 13, wherein the submenu has a radial shape, the items are displayed on hub and spoke style segments of the submenu, and one or more links to other submenus are presented at one of near a center of the submenu and along an outer radius of the submenu.

15. The computing device of claim 13, wherein the submenu appears expanding out from one of: the link on the context based menu and the entire context based menu.

16. The computing device of claim 13, wherein the processor is further configured to:
present a plurality of related submenus in a hierarchical manner such that the link on the context based menu represents a category of commands, each submenu is laid out to present a group of related commands, each submenu includes a back button for reverting to a higher level, and each submenu includes an indication of a link selected at a higher level menu to activate a currently displayed submenu.

17. The computing device of claim 13, wherein the processor is further configured to:
upon displaying the submenu associated with the selected link on the context based menu, marking the link on the context based menu employing one or more of: highlighting the link, shading the link, magnifying the link, and re-coloring the link.

18. A computer-readable memory device with instructions stored thereon for providing a submenu associated with touch or gesture enabled context based menus, the instructions containing:
in response to detecting one of a selection of a portion of displayed content on a user interface and a touch or gesture action on the user interface, presenting a context based menu that includes at least one from a set of a command and a link to a submenu;
in response to detecting selection of the link,
selecting a location for the submenu based on the selected portion of the displayed content and a layout of items to be displayed on the submenu based on a location of the selected link on the context based menu, and
displaying the submenu such that one of: the context based menu disappears, the context based menu remains fully visible, and the context based menu is partially visible overlapped by the submenu, wherein the sub menu presents items that include at least one from a set of another command and a link to another submenu at the selected location; and
in response to a selection of an item on the submenu, one of executing the other command and displaying the other submenu.

19. The computer-readable memory device of claim 18, wherein the instructions further comprise:
displaying the submenu in a substantially radial configuration with the submenu items appearing at positions around a radius of the submenu for enabling a sliding user action around the substantially radial configuration to navigate to and select a submenu item.

20. The computer-readable memory device of claim 18, wherein the instructions further comprise:
enabling selection of a plurality of portions of the displayed content; and
providing a selection item on the submenu to apply one or more commands associated with the selected item on the submenu to the selected portions of the displayed content.
